(19) United States
(12) Patent Application Publication
(10) Pub. No.: US 2011/0127841 A1
(43) Pub. Date: Jun. 2, 2011

(54) Smart virtual low voltage photovoltaic module and photovoltaic power system employing the same

(75) Inventors: Huo-Hsien Chiang, Taipei (TW); Chiou Fu Wang, Yonghe City (TW)

(73) Assignee: Du Pont Apollo Ltd.

(21) Appl. No.: 12/926,562

(22) Filed: Nov. 24, 2010

Related U.S. Application Data
(60) Provisional application No. 61/264,010, filed on Nov. 24, 2009.

(51) Int. Cl. H02J 1/00; G05F 5/00

(52) U.S. Cl. 307/82; 323/299

(57) ABSTRACT

A smart virtual low voltage photovoltaic (PV) module is disclosed, including a PV module having one or more photovoltaic cells, configured to convert solar energy into DC power, and a DC/DC converting unit, coupled between the PV module and a control center coupled to the smart virtual low voltage PV module, configured to acquire from the control center a level value determined by the control center, so as to convert the DC power received from the PV module into a demanded output voltage having the level value.

### FIELD OF THE INVENTION

The invention relates generally to a photovoltaic (PV) module, more particularly, to a smart virtual low voltage photovoltaic module having a low output voltage, and a photovoltaic system employing the same.

### BACKGROUND OF THE INVENTION

Recently, consciousness of environmental problems has spread on a worldwide basis. The photovoltaic industry has been growing at an increasing rate to help meet our world's electricity needs due to the higher safety and readiness in handling of solar power.

Photovoltaic modules utilized in a photovoltaic power system have various forms, typified by such as crystalline silicon PV module, polycrystalline silicon PV module, amorphous silicon PV module, copper-indium-disellinide PV module, cadmium-telluride PV module, gallium-arsenide PV module, and compound semiconductor (e.g., GaInP/GaAs/Ge) PV module. Among these PV modules, thin-film amorphous silicon PV modules produced by depositing silicon on a conductive substrate and forming a transparent conductive layer thereon, are considered promising for the future because they are light-weight and also highly impact resistant and flexible.

Photovoltaic modules having a low output voltage are more favorable because of many advantages, such as lower wiring cost and easier string design. However, typical thin film amorphous silicon photovoltaic modules often have high output voltages, for example, higher than 50 volts. Parallel (instead of serial) connecting PV cells in a PV module to lower down the output voltage of the PV module has been proposed to circumvent this problem. However, the parallel connection creates extra dead areas and thus degrades the efficiency.

### SUMMARY OF THE INVENTION

In view of above, a smart virtual low voltage photovoltaic module having a low output voltage is provided, which can provide advantages such as reduced wire costs and easier string design. Additionally, a photovoltaic power system employing the smart virtual low voltage photovoltaic modules is also provided, which can solve mismatch problems between PV modules and also can have high conversion efficiency.

In one aspect, a smart virtual low voltage photovoltaic module is provided, comprising: a PV module, having one or more photovoltaic cells, configured to convert solar energy into DC power, and a DC/DC converting unit, coupled between the PV module and a control center, configured to acquire from the control center a level value determined by the control center, so as to convert the DC power received from the PV module into a demanded output voltage having the level value.

In another aspect, a PV power system employing the smart virtual low voltage PV module is provided, comprising a control center, configured to determine respective level values for one or more demanded output voltages, one or more smart virtual low voltage PV modules coupled to the control center, each configured as described above, and an inverter, coupled to the one or more smart virtual low voltage PV modules, configured to convert a system output voltage received from the one or more smart virtual low voltage PV modules into an AC voltage.

In further another aspect, a power converting method is provided, comprising converting solar energy into one or more DC input signals, generating instantaneous maximum power information respectively from each of the one or more DC input signals, determining respective level values of one or more demanded output voltages based on the instantaneous maximum power information, and converting the one or more DC input signals respectively into the determined level values of the one or more demanded output voltages.

These and other features, aspects, and embodiments are described below in the section entitled “Detailed Description of the Invention.”

### BRIEF DESCRIPTION OF THE DRAWING

Features, aspects, and embodiments are described in conjunction with the attached drawings, in which:

FIG. 1 is a schematic diagram illustrating an architecture of a smart virtual low voltage PV module in accordance with an embodiment;

FIG. 2 is a schematic diagram illustrating an architecture of a PV power system in accordance with an embodiment; and

FIG. 3 is a flow diagram illustrating determination of level values of demanded output voltages in accordance with an embodiment.

### DETAILED DESCRIPTION OF THE INVENTION

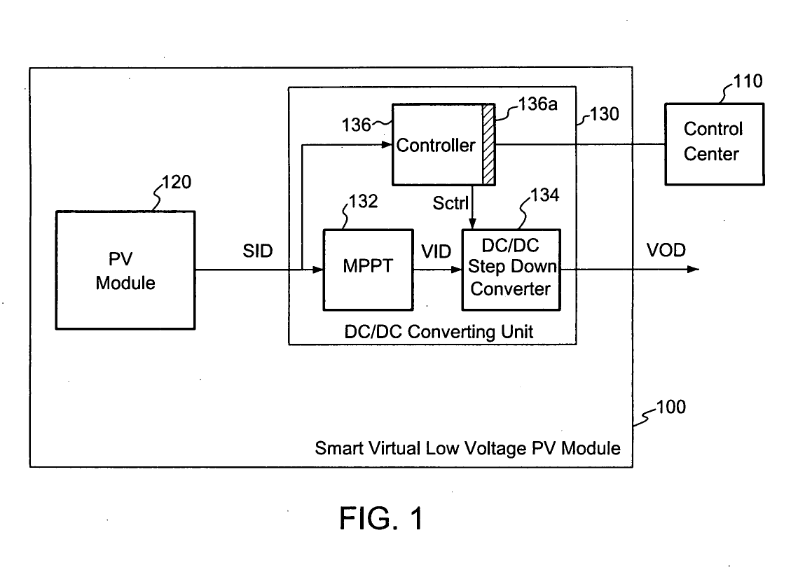

FIG. 1 is a schematic diagram illustrating the architecture of a smart virtual low voltage photovoltaic (PV) module 100 in accordance with an embodiment, where the smart virtual low voltage PV module 100 is able to provide a demanded output voltage VOD having a level value determined by a control center 110 that is wired or wirelessly coupled to the smart virtual low voltage PV module 100. As shown, the smart virtual low voltage PV 100 comprises a PV module 120 and a DC/DC converting unit 130.

The PV module 120 is configured to convert solar energy into DC power for output to the DC/DC converting unit 130. To achieve this, the PV module 120 may have one or more photovoltaic cells (also referred to as solar cells) connected in series, parallel, or combinations of both. Additionally, the PV module 120 can be any type of PV module, such as crystalline silicon PV module, polycrystalline silicon PV module, amorphous silicon PV module, copper-indium-disellinide PV module, cadmium-telluride PV module, gallium-arsenide PV module, compound semiconductor (e.g., GaInP/GaAs/Ge) PV module and other PV modules known to those skilled in the art or commercially available. In a specific embodiment, a thin film amorphous silicon photovoltaic module can be implemented.

The DC/DC converting unit 130, which can be coupled between the PV module 120 and the control center 110, is configured to acquire the level value determined by the control center, so as to convert the DC power output from the PV module 120 into the demanded output voltage VOD having the level value.

In a specific embodiment, after the DC/DC converting unit 130 receives the DC power from the PV module 120, it can report instantaneous maximum power information for the received DC power to the control center 110, wherein the instantaneous maximum power information, for example, can include the maximum power value of the received DC power, or alternatively, the voltage and current values corresponding to the maximum power value. The DC/DC converting unit 130 can then acquire from the control center 110 the level value of the demanded output voltage VOD determined by the control center 110, so as to convert the DC power into the demanded output voltage having the level value.

FIG. 1 also illustrates a detailed embodiment of the DC/DC converting unit 130. As shown, the DC/DC converting unit 130 comprises a maximum power point tracker (MPPT) 132, a DC/DC step down converter 134, and a controller 136.

The MPPT 132, which can be coupled between the PV module 120 and the DC/DC step down converter 134, is configured to track a maximum power operation point for an input DC signal SID generated from the PV module 120, so as to maximize the DC power transferred from the PV module 120 to a load (not shown) coupled (directly or indirectly) with the smart virtual low voltage PV module 100 under various environmental conditions.

The DC/DC step down converter 134, which can be coupled between the MPPT 132 and the controller 136, is configured to convert a DC input voltage VID generated from the MPPT 132 into the demanded output voltage VOD in accordance with a control of the controller 136. Additionally, the level of the demanded output voltage VOD is preferably lower than that of the DC input voltage VID.

The controller 136, which can be coupled between the DC/DC step down converter 134 and the control center 110, is configured to administrate the communication therebetween, thereby determining a voltage conversion ratio for the DC/DC step down converter 134 in accordance with the control of the control center 110. In some embodiments, the controller 136 may be wirelessly coupled with the control center 110. For example, the controller 136 may have a wireless communication interface 136a having wireless communication capability with the control center 110. Alternatively, the controller 136 may be wired coupled with the control center 110.

In the following descriptions, the conversion operation process is explained with reference to the detailed embodiment of the DC/DC converting unit 130.

The DC/DC step down converter 134, after receiving the information about the maximum power operation point (hereafter referred to as “instantaneous maximum power information”) from the MPPT 132, can then transmit the instantaneous maximum power information to the controller 136, which can then forward the instantaneous maximum power information to the control center 110. The instantaneous maximum power information may include the maximum power value for the input DC signal SID generated from the PV module 120, or alternatively, a maximum power voltage and a maximum power current values corresponding to the maximum power value. It can be readily appreciated that in an alternative embodiment, the instantaneous maximum power information can be transmitted directly from the MPPT 132 through the controller 136 to the control center 110.

After receiving the instantaneous maximum power information, the control center 110 can then determine the level value of the demanded output signal VOD based on, among other information (e.g., an optimal input voltage for the inverter), the received instantaneous maximum power information. The control center 110 then sends the determined level value of the demanded output signal VOD back to the controller 136.

The controller 136, after the acquirement of the level value of the demanded output signal VOD from the control center 110, can determine the voltage conversion ratio for the DC/DC step down converter 134. Preferably, the controller 136 determines the voltage conversion ratio according to the voltage value of the input signal SID generated from the PV module 120 and the level value of the demanded output voltage VOD provided by the control center 110. The controller 136 can then generate a controlling signal Sctrl indicative of the voltage conversion ratio for controlling the DC/DC step down converter 134.

In response to the controlling signal Sctrl, the DC/DC step down converter 134 can convert the DC voltage VID by the voltage conversion ratio and generate the demanded output voltage VOD having the level value determined by the control center 110.

One unique feature in the embodiments is the implementation of the DC/DC converting unit 130 which converts the DC input voltage VID into the demanded output voltage VOD whose level is determined by the control center 110 and is lower than the level provided by typical PV modules in the conventional technologies. Benefiting by the lower output voltage level determined by the control center 110, the smart virtual low voltage PV module in the embodiments can achieve many advantages over the conventional technologies.

For example, compared to high wire cost incurred by the high output voltage level of a typical PV module in conventional technologies, the wire cost for the smart virtual low voltage PV module in the embodiments can be considerably reduced.

Additionally, the smart virtual low voltage PV module in the embodiments with a lower output voltage level, when implemented as a string configuration, can achieve a higher resolution of the system voltage so that it is easier to meet the requirement for the operating range of a load (such as an inverter) coupled to the string, thus enabling an easier and better design.

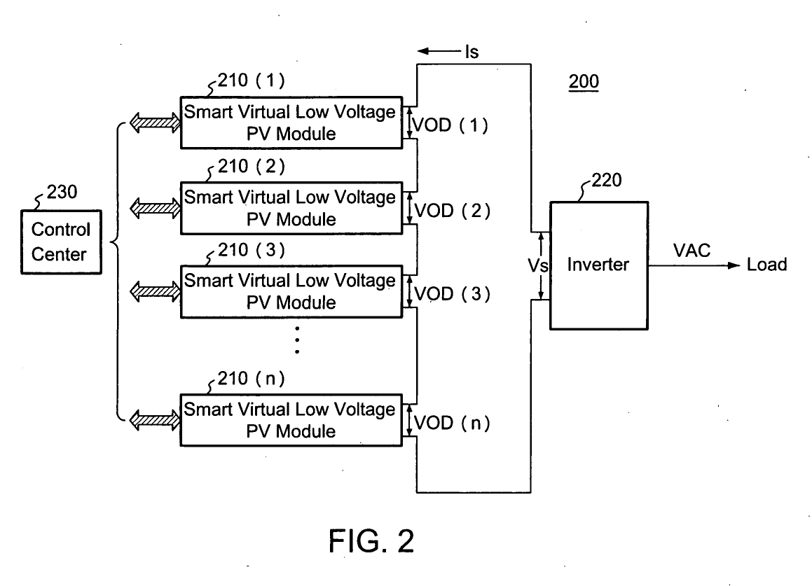

Additionally, the smart virtual low voltage PV module in the embodiments can provide more other advantages due to the instantaneous control by the control center 110, such as high conversion efficiency and circumvention of performance mismatch problems, as will be explained in detail by an embodiment associated with the photovoltaic power system of FIG. 2

FIG. 2 is a schematic diagram illustrating the architecture of a photovoltaic (PV) power system 200 employing the smart virtual low voltage PV module 100 of FIG. 1 in accordance with an embodiment. As shown, the PV power system 200 comprises a plurality of smart virtual low voltage PV modules 210(1)˜210(n) (where n is a positive integer), an inverter 220, and a control center 230 that is wired or wireless coupled to the smart virtual low voltage PV modules 210(1)˜210(n).

Each of the smart virtual low voltage PV modules 210(1)˜210(n) is configured as the smart virtual low voltage PV module 100 and controlled by the control center 230 as described in connection with FIG. 1.

In a preferred embodiment as shown, the smart virtual low voltage PV modules 210(1)˜210(n) can be series connected as a string, so as to collectively provide a system output voltage Vs and a string current Is for input to the inverter 220. Described in detail, one input node of the inverter 220 serves as an input to the first virtual low voltage PV modules 210(1). Additionally, each of the virtual low voltage PV modules 210(1)˜210(n) connected in series can provide the respective demanded output voltage VOD(1)˜VOD(n). Moreover, each of the virtual low voltage PV modules 210(1)˜210(n) has the same output current; i.e., the string current Is.

The inverter 220, coupled between the string of the smart the virtual low voltage PV modules 210(1)˜210(n) and a load such as a power grid (not shown), is configured to convert the system output voltage Vs into an AC voltage VAC for output to the load. The system output voltage Vs can be fixed at a predetermined value, which in a preferred embodiment, is substantially equal to the optimal input voltage of the inverter 220 used in the PV power system 200.

As described in connection with FIG. 1, each of the smart virtual low voltage PV modules 210(i) in the string (i is an integer between 1˜n) can individually report the instantaneous maximum power information to the control center 230. The respective instantaneous maximum power information for the smart virtual low voltage PV modules 210(1)˜210(n) can include the maximum power value Pmp(1)˜Pmp(n), or alternatively, the maximum power voltage value Vmp(1)˜Vmp(n) and the maximum power current value Imp(1)˜Imp(n), wherein Pmp(i)=Vmp(i)*Imp(i).

The control center 230, after acquirement of the instantaneous maximum power information from all the smart virtual low voltage PV modules 210(1)˜210(n), can determine the level values of the respective demanded output voltages VOD(1)·VOD(n) based on the instantaneous maximum power information gathered from all the virtual low voltage PV modules 210(1)˜210(n). The control center 230 then provides the level values of the respective demanded output voltages VOD(1)˜VOD(n) respectively to the virtual low voltage PV modules 210(1)˜210(n).

In accordance with equations of the system power production: Ps=Vs*Is and Ps=P(1)+P(2)+ . . . +P(n)=Is*(VOD(1)+VOD(2)+ . . . +VOD(n)), where P(i)=the power value of the virtual low voltage PV module 210(i), the system output voltage Vs is relevant to the respective power values P(1)˜P(n) of the virtual low voltage PV modules 210(1)˜210(n), and is also relevant to the demanded output voltages VOD(1)˜VOD(n).

Moreover, the power production of the respective PV module (not shown in FIG. 2) within each virtual low voltage PV module 210(i) may dominate the whole power production (denoted as the power value P(i)) of the virtual low voltage PV module 210(i). That is, the power consumption contributed by the respective DC/DC converting unit (not shown in FIG. 2) in the virtual low voltage PV module 210(i) can be omitted in calculating the power value P(i). According to the above equations: Ps=Vs*Is and Ps=P(1)+P(2)+ . . . +P(n), the system output voltage Vs may therefore be approximately proportional to the total power production of the total PV modules within PV modules 210(1)˜210(n), with the power consumption of the DC/DC converting units within the PV modules 210(1)˜210(n) omitted.

Preferably, each virtual low voltage PV module 210(i) is set to operate at the respective maximum power operation point, that is, (P(1)+P(2)+ . . . +P(n))□(Pmp(1)+Pmp(2)+ . . . +Pmp(n)), so as to maximize the power conversion efficiency of the PV power system 200.

Given the above, with appropriate determinations of the demanded output voltages VOD(1)˜VOD(n) by the control center 230, not only can the PV modules 210(1)˜210(n) collectively provide the inverter 220 with the system output voltage Vs equal to the optimal input voltage of the inverter 22, but also the virtual low voltage PV modules 210(1)˜210(n) can each operate at respective maximum power operation points to have the maximum power conversion efficiency.

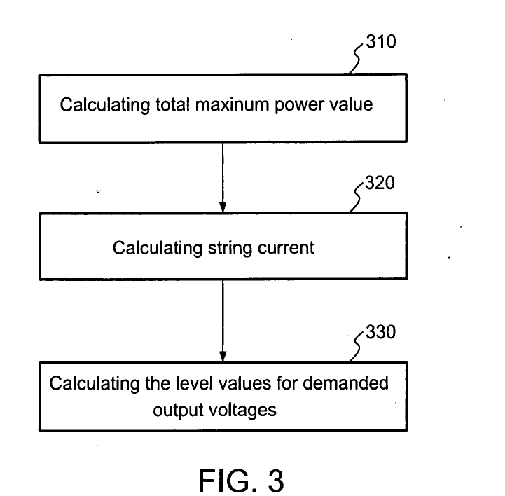

FIG. 3 is a flow diagram illustrating the determination process of the level values of the demanded output voltages VOD(1)˜VOD(n) for the control center 230 of FIG. 2 in accordance with an embodiment. The embodiment is shown for an idealized case, where the conversion power loss of the DC/DC converting unit in each smart virtual low voltage PV module is neglected.

As shown, in step 310, because the power consumption of the DC/DC converting unit in each smart virtual low voltage PV module is neglected, the control center 230 can calculate the total maximum power value Ps of the smart virtual low voltage PV modules 210(1)˜210(n) by summing up all the maximum power values Pmp(1)˜Pmp(n) respectively gathered from the smart virtual low voltage PV modules 210(1)˜210(n).

Next, in step 320, the control center 230 calculates the string current Is based on the system output voltage Vs (equal to a predetermined value) and the total maximum power value Ps as: Is=Ps/Vs.

Next, in step 330, because in the string configuration, the output current for each smart virtual low voltage PV module 210(i) is the same (i.e., Is), the control center 230 can calculate the respective level value of the demanded output voltage VOD(i) for each smart virtual low voltage PV module 210(i) as: VOD(i)=Pmp(i)/Is.

Consequently, the PV power system 200 can meet the requirement for a constant predetermined value of the system output voltage Vs, while each smart virtual low voltage PV module 210(i) in the string can also operate at the respective maximum power point.

The determination illustrated in the embodiment of FIG. 3 neglects the power consumption of the DC/DC converting unit within each smart virtual low voltage PV module. However, it can be appreciated that, in other embodiments, the power consumption of the DC/DC converting unit can be involved in the determination procedure by including an additional correction step, thereby obtaining more accurate level values of the demanded output voltages VOD(1)˜VOD(n).

Referring back to FIG. 2, the PV power system 200 can achieve many advantages over the conventional technologies as detailed below.

First, compared to the conventional technologies that employ typical high-voltage PV modules (e.g., amorphous silicon monolithic thin film PV module), whose output voltages are directly provided to an inverter without level conversion, the output levels of the smart virtual low voltage PV modules 210(1)˜210(n) utilizing voltage converting units can be lower. Accordingly, the wire costs in the PV power system 200 can be considerably reduced.

Second, because the instantaneous maximum power information of the smart virtual low voltage PV module 210(1)˜210(n) are promptly reported to the demanded output voltages VOD(1)˜VOD(n), the smart virtual low voltage PV module 210(1)˜210(n) can always operate at the respective maximum power point, thus maintaining high conversion efficiency under various conditions, such as different temperatures and sun irradiations.

Third, because the level values of the demanded output voltages VOD(1)˜VOD(n) for the smart virtual low voltage PV modules 210(1)˜210(n) are individually determined, all of the smart virtual low voltage PV modules 210(1)˜210(n) can operate at the respective maximum power point. Accordingly, the PV power system 200 can avoid the mismatch problem with the conventional technologies that the PV modules cannot all operate at maximum power pints due to variations in shade, degradation, and fabrication.

Fourth, the PV power system 200 can operate with only one inverter 220 between the PV modules 210(1)˜210(n) and the load, thus saving complex circuitry for connection to the load required in the conventional technologies, such as islanding detection and protection circuit, and synchronous sinusoidal waveform generation circuit with the required AC power quality for grid-tied application.

Although only one control center 230 is disposed in the embodiment for controlling all the smart virtual low voltage PV modules 210(1)˜210(n), it can be readily appreciated that, in other embodiments, more than one control centers can be implemented, each controlling one corresponding smart virtual low voltage PV module.

Additionally, although only one inverter 220 is disposed in the embodiment for converting the system output voltage Vs of the string of the smart virtual low voltage PV modules 210(1)˜210(n), it can be readily appreciated that in other embodiments, more than one inverters can be implemented, each converting an output voltage of corresponding smart virtual low voltage PV module(s).

Additionally, although only one string of smart virtual low voltage PV modules 210(1)˜210(n) is shown in the embodiment for converting the output voltage (i.e., the system voltage Vs), it can be readily appreciated that in other embodiments, more than one strings can be implemented, each associated with one or more control centers.

While certain embodiments have been described above, it will be understood that the embodiments described are by way of example only. Accordingly, the device and methods described herein should not be limited to the described embodiments. Rather, the device and methods described herein should only be limited in light of the claims that follow when taken in conjunction with the above description and accompanying drawings.

What is claimed is:

1. A smart virtual low voltage photovoltaic (PV) module coupled to a control center, the module comprising:
a PV module, having one or more photovoltaic cells, configured to convert solar energy into DC power; and
a DC/DC converting unit, coupled between the PV module and control center, configured to acquire a level value determined by the control center, so as to convert the DC power received from the PV module into a demanded output voltage having the level value.

2. The smart virtual low voltage photovoltaic PV module of claim 1, wherein the DC/DC converting unit provides the control center with instantaneous maximum power information for the DC power output from the PV module.

3. The smart virtual low voltage photovoltaic PV module of claim 1, wherein the DC/DC converting unit is wirelessly coupled to the control center.

4. The smart virtual low voltage photovoltaic PV module of claim 1, wherein the DC/DC converting unit comprises:
a maximum power point tracker, configured to track a maximum power operation point for the DC power received from the PV module;
a DC/DC step down converter, configured to convert a DC input voltage generated from the maximum power point tracker into the demanded output voltage; and
a controller, coupled between the DC/DC step down converter and the control center, configured to determine a voltage conversion ratio for the DC/DC step down converter in accordance with the control of the control center.

5. The smart virtual low voltage photovoltaic PV module of claim 4, wherein the controller provides the control center with instantaneous maximum power information for the DC power output from the PV module and determines the voltage conversion ratio based on the level value of the demanded output voltage received from the control center.

6. The smart virtual low voltage photovoltaic PV module of claim 4, wherein the controller has a wireless communication interface having wireless communication capability with the control center.

7. A photovoltaic (PV) power system, comprising:
a control center, configured to determine respective level values for one or more demanded output voltages;
one or more smart virtual low voltage PV modules coupled to the control center, each comprising:
a PV module, having one or more photovoltaic cells, configured to convert solar energy into DC power; and
a DC/DC converting unit, coupled between the PV module and the control center, configured to acquire from the control center one of the level values to convert the DC power received from the PV module into a corresponding one of the one or more demanded output voltages having the level value; and
an inverter, coupled to the one or more smart virtual low voltage PV modules, configured to convert a system output voltage received from the one or more smart virtual low voltage PV modules into an AC voltage.

8. The PV power system of claim 7, wherein the DC/DC converting unit in each smart virtual low voltage PV module is wirelessly coupled to the control center.

9. The PV power system of claim 7, wherein the DC/DC converting unit in each smart virtual low voltage PV module comprises:
a maximum power point tracker, configured to track a maximum power operation point for the DC power received from the PV module;
a DC/DC step down converter, configured to convert a DC input voltage generated from the maximum power point tracker into the demanded output voltage;
a controller, coupled between the DC/DC step down converter and the control center, configured to determine a voltage conversion ratio for the DC/DC step down converter in accordance with the control of the control center.

10. The PV power system of claim 9, wherein the respective controller in each smart virtual low voltage PV module provides the control center with instantaneous maximum power information for the DC power output from the PV module and determines the voltage conversion ratio based on the level value of the demanded output voltage received from the control center.

11. The PV power system of claim 9, wherein the controller has a wireless communication interface having wireless communication capability with the control center.

12. The PV power system of claim 7, wherein the control center determines the respective level values of one or more demanded output voltage based on the respective maximum power values of the one or more smart virtual low voltage PV modules.

13. The PV power system of claim 7, wherein the one or more smart virtual low voltage PV modules are connected as a string.

14. The PV power system of claim 8, wherein in determination of the respective level values of one or more demanded output voltages, the control center calculates the total maximum power value of the one or more smart virtual low voltage PV modules, calculates a string current based on the system output voltage and the total maximum power value, and calculates the level value of each demanded output voltage based on the corresponding maximum power value and the string current.

15. The PV power system of claim 7, wherein the control center determines the respective level values of one or more demanded output voltages based on a condition that the system output voltage is an optimal input voltage of the inverter.

16. The PV power system of claim 7, wherein the control center determines the respective level values of one or more demanded output voltages based on a condition that each of the one or more virtual low voltage PV modules operates at a respective maximum power operation point.

17. A power converting method, comprising the following steps:
converting solar energy into one or more DC input signals;
generating respective instantaneous maximum power information from each of the one or more DC input signals;
determining respective level values for one or more demanded output voltages based on the instantaneous maximum power information;
converting the one or more DC input signals respectively into the determined level values of the one or more demanded output voltages.

18. The power converting method of claim 17, wherein the step of determining respective level values of one or more demanded output voltages comprises:
calculating a total maximum power value based on the instantaneous maximum power information of the one or more DC input signals;
calculating a string current based a predetermined voltage and the total maximum power value; and
calculating the respective level value of each demanded output voltage based on the corresponding maximum power value and the string current.

19. The power converting method of claim 17, wherein the determining respective level values of one or more demanded output voltages is based on a condition that the predetermined voltage is an optimal input voltage of an inverter.

20. The power converting method of claim 17, wherein the determining respective level values of one or more demanded output voltages is based on one or more maximum power operation points of the one or more DC input signals.
